(19) United States
(12) Patent Application Publication
(10) Pub. No.: US 2015/0149376 A1
(43) Pub. Date: May 28, 2015

(54) System for Providing Community-Based Accelerated Learning

(71) Applicant: Robert Brazell, Salt Lake City, UT (US)

(72) Inventor: Robert Brazell, Salt Lake City, UT (US)

(21) Appl. No.: 14/553,743

(22) Filed: Nov. 25, 2014

Related U.S. Application Data
(60) Provisional application No. 61/908,655, filed on Nov. 25, 2013.

(51) Int. Cl. G09B 5/08; G06Q 50/00; G06Q 20/06; H04L 29/08

(52) U.S. Cl. CPC G09B 5/08; H04L 67/10; G06Q 50/01; G06Q 20/06
USPC 705/319

(57) ABSTRACT

Community-based accelerated learning provides a system where knowledge can be obtained in a simplified and optimized manner by presenting information in an incremental manner using a canonical curriculum. Community-based accelerated learning also provides an economic model for exchanging knowledge for currency. Community-based accelerated learning also provides an environment in which a user's digital representative (or avatar) can continuously search for sources of knowledge or experiences that match a user's specified goals.

### CROSS-REFERENCE TO RELATED APPLICATIONS

This application claims priority to U.S. Provisional Patent Application No. 61/908,655 filed on Nov. 25, 2013.

### BACKGROUND

Even though advances in technology have provided virtually unlimited access to information, current models for accessing and sharing this information are ineffective. For example, the sheer amount of information available is oftentimes the largest hurdle to accessing the most relevant information. Consequently, it often requires a substantial amount of time and effort to locate relevant information. Even when relevant information is located, it can require even more time and effort to understand and apply such information due to the variations in terms and concepts used to provide such information.

### BRIEF SUMMARY

The present invention extends to methods, systems, and computer program products for providing community-based accelerated learning. Community-based accelerated learning provides a system where knowledge can be obtained in a simplified and optimized manner by presenting information in an incremental manner using a canonical curriculum. The canonical curriculum organizations information into various disciplines and uses a canonical glossary of terms for presenting information within the disciplines. By presenting information across disciplines using a common glossary of terms, a user can quickly and efficiently obtain knowledge about a new discipline without investing substantial amounts of time learning new terms for each discipline. Community-based accelerated learning therefore provides a model for optimizing the knowledge acquisition process. More knowledge can therefore be obtained in less time leading to greater happiness.

Community-based accelerated learning also provides an economic model for exchanging knowledge for currency. As a user masters a particular increment within a discipline, the user's knowledge obtained through this mastery can be represented in a standard way. Then, other users seeking to obtain the same knowledge can exchange currency for the opportunity to receive the knowledge from the user. Because knowledge is represented in a standard manner, identifying a source of the knowledge is facilitated. In this way, the time and effort that would otherwise be required under current learning schemes can be spent in other ways including in obtaining greater amounts of knowledge.

Community-based accelerated learning also provides an environment in which a user's digital representative (or avatar) can continuously search for sources of knowledge or experiences that match a user's specified goals. In this way, users can specify types of knowledge or experiences that they would like to obtain and allow their avatars to search for the optimal sources of the desired knowledge or experience thereby relieving the user from much of the effort required to obtain the knowledge or experience. Also, the avatars can be sufficiently intelligent to make decisions for the users regarding the allocation of the user's resources (e.g. time and money) while pursuing specified knowledge goals. For example, a user can specify various weights to assign to the pursuit of different types of knowledge and allow the avatar to balance the user's resources based on these assigned weights. In this way, the user need only follow the advice of his avatar to obtain the desired level of knowledge across multiple disciplines.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer environment in which the present invention can be implemented;

FIG. 2 illustrates a system that defines multiple disciplines and a common curriculum across the discipline;

FIG. 3 illustrates levels of a discipline; and

FIG. 4 illustrates an example user interface that can be displayed to a user to allow the user to identify sources of knowledge in accordance with one or more embodiments of the invention.

### DETAILED DESCRIPTION

The present invention extends to methods, systems, and computer program products for providing community-based accelerated learning. Community-based accelerated learning provides a system where knowledge can be obtained in a simplified and optimized manner by presenting information in an incremental manner using a canonical curriculum. The canonical curriculum organizations information into various disciplines and uses a canonical glossary of terms for presenting information within the disciplines. By presenting information across disciplines using a common glossary of terms, a user can quickly and efficiently obtain knowledge about a new discipline without investing substantial amounts of time learning new terms for each discipline. Community-based accelerated learning therefore provides a model for optimizing the knowledge acquisition process. More knowledge can therefore be obtained in less time leading to greater happiness.

Community-based accelerated learning also provides an economic model for exchanging knowledge for currency. As a user masters a particular increment within a discipline, the user's knowledge obtained through this mastery can be represented in a standard way. Then, other users seeking to obtain the same knowledge can exchange currency for the opportunity to receive the knowledge from the user. Because knowledge is represented in a standard manner, identifying a source of the knowledge is facilitated. In this way, the time and effort that would otherwise be required under current learning schemes can be spent in other ways including in obtaining greater amounts of knowledge.

Community-based accelerated learning also provides an environment in which a user's digital representative (or avatar) can continuously search for sources of knowledge or experiences that match a user's specified goals. In this way, users can specify types of knowledge or experiences that they would like to obtain and allow their avatars to search for the optimal sources of the desired knowledge or experience thereby relieving the user from much of the effort required to obtain the knowledge or experience. Also, the avatars can be sufficiently intelligent to make decisions for the users regarding the allocation of the user's resources (e.g. time and money) while pursuing specified knowledge goals. For example, a user can specify various weights to assign to the pursuit of different types of knowledge and allow the avatar to balance the user's resources based on these assigned weights. In this way, the user need only follow the advice of his avatar to obtain the desired level of knowledge across multiple disciplines.

### Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

### Example Computer Environment

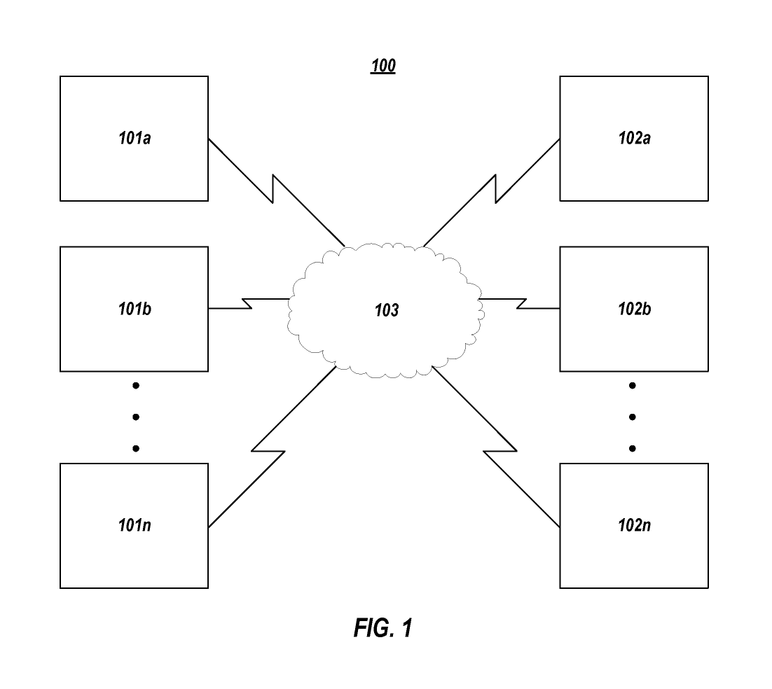

FIG. 1 illustrates an example computer environment 100 in which the present invention can be implemented. Computer environment 100 includes server computing systems 101a-101n and client computing devices 102a-102n which are connected via a network 103. Computer environment 100 in a typical environment can represent the internet.

Server computing systems 101a-101n represent any type of computer system connected to network 103 that stores content accessible from one or more of client computer devices 102a-102n. For example, each of server computing systems 101a-101n can comprise any number of computer systems or resources such as a single server or a cloud of interconnected computer resources. In other words, the present invention should not be limited to any particular computer or network configuration or infrastructure.

Client computing devices 102a-102n can represent any type of computing device capable of communicating with any of server computing systems 101a-101n over network 103. Examples of client computing devices 102a-102n include desktop computers, laptop computers, tablets, mobile phones, other smart electronic devices, etc. Although in most implementations, network 103 will be the internet, any type of network or direct connection between a client computer device 102 and a server computing system 101 could be used in addition to or in place of the internet.

Community-Based Accelerated Learning

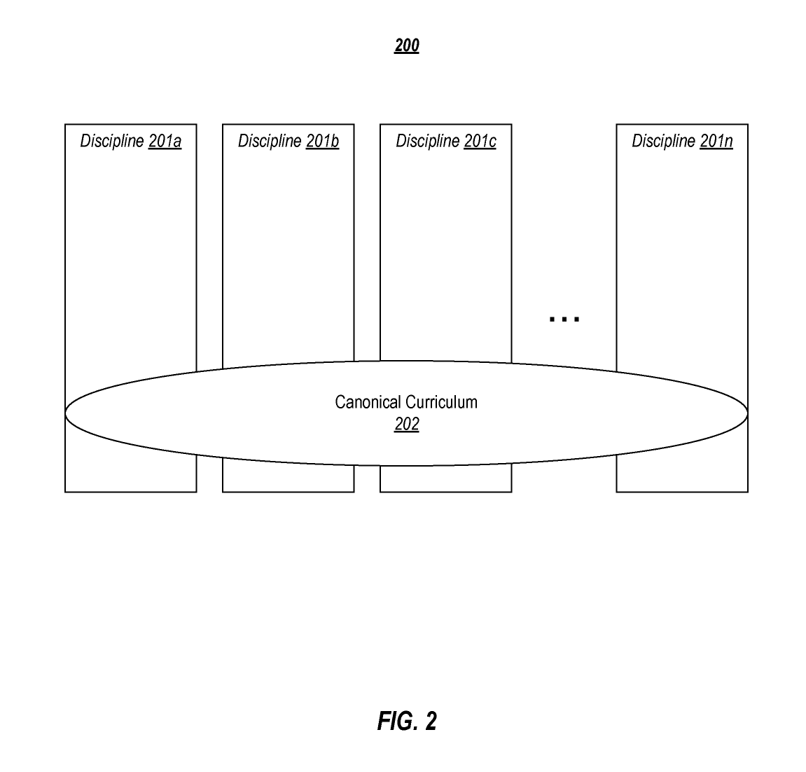

FIG. 2 illustrates an example of a system 200 for providing community-based accelerated learning in accordance with one or more embodiments of the invention. As shown, system 200 is divided into a plurality of disciplines 201a-201n. To facilitate obtaining knowledge across disciplines, system 200 defines a canonical curriculum 202 that spans each discipline 201a-201n.

Canonical curriculum 202 defines a canonical glossary of terms. The canonical glossary defines a set of terms that are commonly used across disciplines. For example, in current educational systems, each discipline oftentimes uses terms that are unique to the discipline even though the terms refer to things that are common across disciplines. Because of this, when a user attempts to obtain knowledge about a new discipline using existing systems, the user often has to learn the meaning of the terms unique to the new discipline which slows the learning process. This issue is compounded when the same terms are used to refer to different things in different disciplines.

To simplify the learning process, system 200 employs the canonical glossary of terms so that a user need only learn the canonical terms once. Then, when the user encounters the use of the term in a new discipline, the user will know that the term is used with its canonical meaning as defined by canonical curriculum 200.

Each discipline 201a-201n can be organized into tiers or increments with each increment building on the knowledge provided by lower increments. The canonical glossary of terms can be particularly beneficial for providing knowledge at the lower or lowest increments of a discipline. Because the information is provided at these lower increments in a more general and basic form, the canonical terms are oftentimes satisfactory for conveying knowledge at these levels. As a user moves upward to higher increments within a discipline, additional terms that may be unique to the discipline will be more frequently used to convey a higher level of knowledge regarding the discipline. As can be seen, the canonical terms allow a user to quickly obtain an introductory amount of knowledge regarding a particular discipline.

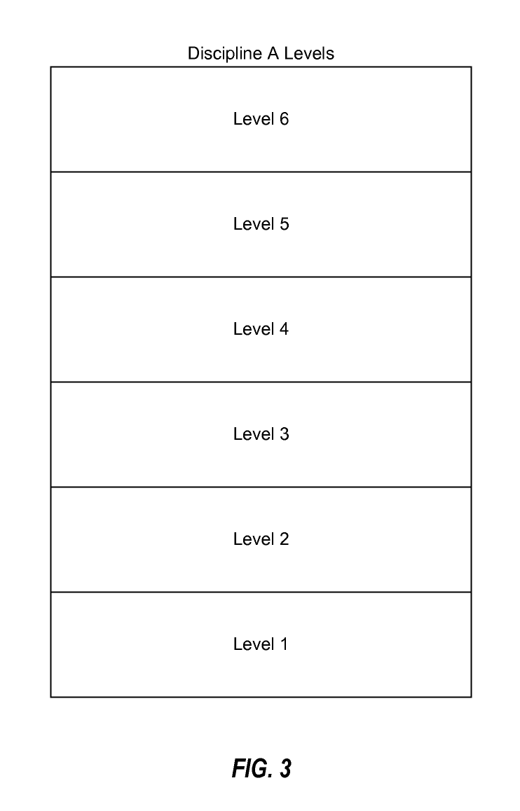

FIG. 3 illustrates how a particular discipline can be arranged into levels or increments. As shown, discipline A is divided into six different levels with each higher level building on the levels below it. As a user masters the knowledge in a particular level, a common representation can be used to represent the user's mastery of the particular level. For example, a user having mastered level 3 of discipline A can have a representation defining a mastery level of 3 for discipline A. This common representation can be used in an economic model to enable the user to present his knowledge that he is willing to share with other users within the model. Mastery of a level can be defined as having learned the knowledge of that level. This mastery can be determined by various means such as by completing tests, performing tasks, or performing skills that require knowledge of that level.

A user seeking to obtain knowledge regarding discipline A can search for other users having obtained mastery of one or more levels of discipline A. Each of these users can present offers for “selling” this knowledge. These offers can be based on an exchange of a currency common to the system. In other words, users having obtained a mastery of one or more levels of a discipline can offer to provide knowledge of one or more of these levels to another user in exchange for a specified amount of currency. In this way, a marketplace for the exchange of knowledge can be provided. This marketplace, in some embodiments, can be implemented as a social network.

The use of a common representation of mastery of a discipline facilitates identifying a source of knowledge. For example, a user having mastered level 6 of discipline A may offer to provide the knowledge of level 1 for a higher price than a user having mastered only level 3 of the discipline because other users may be willing to pay more to learn from someone viewed to be an expert. Therefore, the common representation provides a simplified and direct way to identify good sources of knowledge.

In some embodiments, a user can be represented by one or more avatars within system 200. These avatars can obtain information about their user to enable the avatars to identify and recommend types of knowledge the user should pursue as well as the sources to select for obtaining the knowledge. In other words, the avatars can be continuously searching for available sources of knowledge and making recommendations of particular sources that the user should pursue to obtain a certain level of knowledge.

In some embodiments, the user can specify how much time or resources he desires to spend obtaining each type of knowledge. Then, his avatar can identify the most economical and efficient way to obtain this knowledge. For example, if the user has specified a desire to obtain mastery of level 2 in discipline A, but only desires to spend 10% of this time doing so, his avatar may identify a source of level 2 knowledge (e.g. someone having a mastery level of at least 2 in discipline A) that can provide this knowledge in a manner that matches the user's criteria. In this case, the source may be someone who is willing to devote the required amount of time teaching the knowledge.

In some embodiments, each user's avatar can provide the common representation of the user's mastery level of each discipline as well as other indicators such as a success rate of the user for conveying knowledge, a cost for conveying knowledge, etc. Such indicators can further facilitate the identification of a viable source for obtaining desired knowledge.

In some embodiments, the avatars can function in a marketplace such as the personal decision marketplace described in commonly-owned U.S. patent application Ser. No. 13/926,965 which is incorporated herein by reference. Specifically, a user's avatar can be used to enter into personal decision contracts with other user's avatars for providing and obtaining knowledge.

The present invention therefore provides an environment in which a user can trade knowledge for further knowledge in a simplified and optimized manner. By providing current knowledge to other users, the user can obtain currency which can then be used to obtain further knowledge from other users. Because a canonical glossary is used, users may obtain introductory knowledge in many disciplines in an expedited, efficient fashion. Further, the common representation of knowledge allows other users to quickly identify sources of knowledge resulting in accelerated learning.

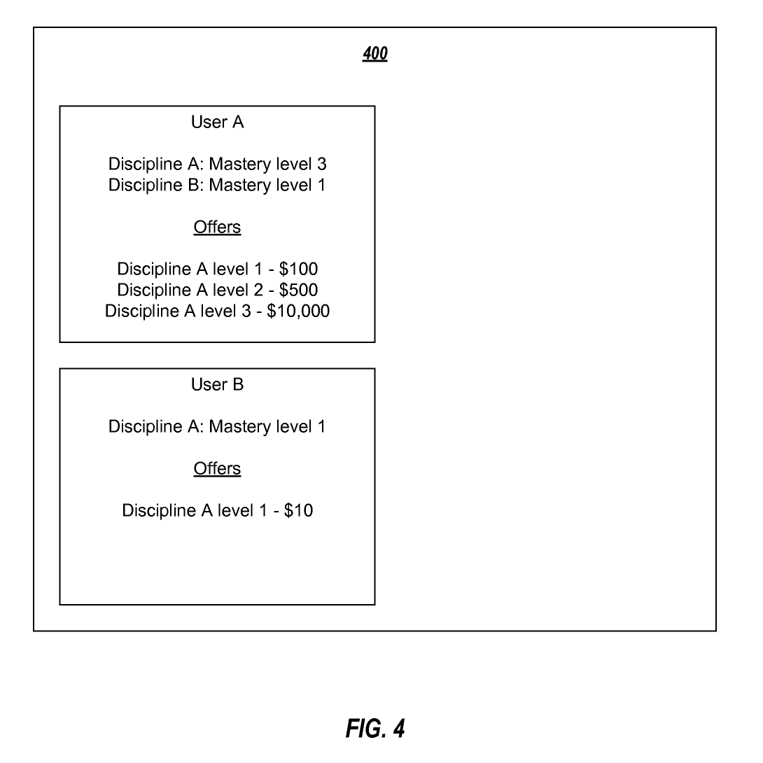

FIG. 4 illustrates an example user interface 400 that can be displayed to a user to allow the user to identify sources of knowledge in accordance with one or more embodiments of the invention. User interface 400 displays information about two users: user A and user B. User A has a mastery level in discipline A of 3 and a mastery level in discipline B of 1, whereas user B has a mastery level in discipline A of 1. User A is offering to provide knowledge of discipline A. These offers include providing level 1 knowledge for $100, level 2 knowledge for $500, and level 3 knowledge for $10,000. User B, on the other hand, is offering to provide level 1 knowledge for $10.

A user can decide whether to use his common currency to purchase the opportunity to obtain the level 1 knowledge from user A or user B. For example, the user may be willing to pay more to learn from user A because of user A's mastery level of 3 for discipline A.

In some embodiments, user interface 400 can provide additional information about each user such as the amount of time or resources each user is willing to spend each day providing knowledge, reviews from other users that have obtained knowledge from the user, a success rate of the user in providing the knowledge (e.g. a percentage of users that successfully master the level after the user has taught the knowledge of that level), etc.

As an example, assuming discipline A is law and level 3 mastery represents sufficient knowledge to sit for a state bar, a user interested in becoming a lawyer may be willing to pay user A $10,600 to obtain the knowledge of levels 1-3. In contrast, a user interested only in obtaining a basic introduction to law may choose to pay user B $10 to obtain the knowledge of level 1. As can be seen, the marketplace enables a user to identify a source of knowledge that is appropriate for each scenario.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for providing community-based, accelerated learning, the method comprising:
establishing a plurality of disciplines, each discipline being divided into a plurality of levels of knowledge with each higher level building on the knowledge of lower levels;
providing a common representation of mastery of a discipline, the common representation defining a level to which a user has mastered a discipline; and
providing a currency that can be offered in exchange for the provision of knowledge of a level of a discipline.

2. The method of claim 1, further comprising:
receiving an offer from a first user to provide knowledge of a specified level of a discipline to another user for an amount of the currency; and
presenting the offer to other users.

3. The method of claim 1, further comprising:
using the common representation to assign a mastery level to a particular user; and
presenting the user's mastery level to other users.

4. The method of claim 1, further comprising:
defining a canonical glossary of terms that are common across a plurality of the disciplines.

5. A system for providing community-based, accelerated learning, the system comprising:
one or more processors; and
memory storing computer executable instructions which when executed by the one or more processors implement a social network in which users are assigned a mastery level for one or more disciplines in which the users have obtained a specified amount of knowledge, and other users make offers to obtain a level of knowledge from the users in exchange for currency.

6. The system of claim 5, wherein the social network defines a canonical glossary of terms that are used across disciplines.

7. The system of claim 5, wherein the social network employs avatars to represent users in identifying sources of knowledge.
